(19) United States
(12) Patent Application Publication
(10) Pub. No.: US 2011/0175851 A1
(43) Pub. Date: Jul. 21, 2011

(54) ELECTRONIC PEN FOR DETECTING TOUCH LOCATION, CONTROLLING METHOD OF THE SAME, AND DRIVING METHOD OF PLASMA DISPLAY APPARATUS

(76) Inventors: Hyun-Chul Do, Yongin-si (KR); Im-Su Choi, Yongin-si (KR); Young-Sun Kim, Yongin-si (KR)

(21) Appl. No.: 12/850,069

(22) Filed: Aug. 4, 2010

Related U.S. Application Data
(60) Provisional application No. 61/297,243, filed on Jan. 21, 2010.

(51) Int. Cl. G09G 3/28; G06F 3/042

(52) U.S. Cl. 345/175; 345/60

(57) ABSTRACT

An electronic pen for detecting a touch location, a controlling method of the same and a driving method of a plasma display apparatus are disclosed. According to embodiments of the present invention, synchronization between the electronic pen and the plasma display apparatus may be performed. An electronic pen includes a sensor for receiving infrared emissions and for generating a plurality of sensing signals in response to the infrared emissions, a synchronization unit for determining a synchronization timing in accordance with timings of the plurality of sensing signals, and a coordinate detection unit for detecting an emission location of the infrared emissions in accordance with time differences between the synchronization timing and the timings of the plurality of sensing signals.

### CROSS-REFERENCE TO RELATED APPLICATIONS

This application claims priority to and the benefit of U.S. Provisional Application No. 61/297,243, filed on Jan. 21, 2010, in the United States Patent and Trademark Office, the disclosure of which is incorporated herein in its entirety by reference.

### BACKGROUND

1. Field

Aspects of embodiments of the present invention relate to an electronic pen for detecting a touch location, a controlling method of the same, and a driving method of a plasma display apparatus.

2. Description of Related Art

When a user applies a manipulation signal to a display apparatus such as a TV or a monitor, a remote controller or a mouse may be used. In addition, electronic pens may be utilized for directly drawing a picture or applying a manipulation signal on a display apparatus. The operation of an electronic pen utilizes a technology for sensing whether or not an object touches a display panel and a technology for detecting a touch location by the object.

In a method of operating an electronic pen, the electronic pen generates an infrared ray or an ultrasonic wave, the display panel senses the infrared ray or the ultrasonic wave generated by the electronic pen, and a touch location touched by the electronic pen on the display panel is detected.

In another method of operating an electronic pen, the electronic pen senses an infrared ray generated by a display panel and a touch location touched by the electronic pen on the display panel is detected. For example, an infrared ray generated from a discharge cell of a plasma display panel is sensed by the electronic pen to detect a touch location.

### SUMMARY

Aspects of embodiments of the present invention are directed toward an electronic pen for accurately detecting a touch location, a controlling method of the same, and a driving method of a plasma display apparatus.

According to an embodiment of the present invention, a detection device includes a sensor for receiving infrared emissions and for generating a plurality of sensing signals in response to the infrared emissions, a synchronization unit for determining a synchronization timing in accordance with timings of the plurality of sensing signals, and a coordinate detection unit for detecting a location of the detection device in accordance with time differences between the synchronization timing and the timings of the plurality of sensing signals.

The synchronization unit may be adapted to generate the synchronization timing by comparing the timings of at least three consecutive sensing signals among the sensing signals with a synchronization condition.

The detection device may be configured to compare a first value with a time period between a first one and a second one of the at least three consecutive sensing signals, and to compare a second value with a time period between the second one and a third one of the at least three consecutive sensing signals, to determine the synchronization condition.

The coordinate detection unit may be adapted to generate a vertical coordinate in accordance with a time period between the synchronization timing and a vertical coordinate detection signal of the sensing signals, and the coordinate detection unit may be adapted to generate a horizontal coordinate in accordance with a time period between the synchronization timing and a horizontal coordinate detection signal of the sensing signals.

The sensor may include an infrared sensor for generating the plurality of sensing signals, and an amplifier coupled to the infrared sensor and configured for amplifying the plurality of sensing signals.

The detection device may further include a low pass filter for removing high frequency components of the sensing signals. The high frequency components correspond to a time period between two of the infrared emissions from two adjacent pixels, respectively, of a display apparatus.

The detection device may further include a comparison unit for comparing a value of one of the sensing signals with a reference value such that the value of one of the sensing signals is greater than the reference value when the device is sufficiently close to the infrared emissions.

The detection device may further include a communication unit for transmitting coordinates of the location of the detection device as an output.

According to an embodiment of the present invention, a method of driving a plasma display panel of a display apparatus to detect a touch location of a device on the plasma display panel is provided. The plasma display panel includes a plurality of first electrodes and a plurality of third electrodes extending in a first direction and a plurality of second electrodes extending in a second direction crossing the first direction. The plasma display panel is driven in a frame including a plurality of subfields and a coordinate detection period. The method includes applying a Y coordinate detection signal to the first electrodes during a Y coordinate detection period of the coordinate detection period, applying an X coordinate detection signal to the second electrodes during an X coordinate detection period of the coordinate detection period, applying a plurality of synchronization signals concurrently to the first electrodes and the third electrodes during a synchronization period of the coordinate detection period, receiving coordinates of the touch location from the device in data communication with the display apparatus, and driving the plasma display panel during the plurality of subfields to display the touch location. The coordinates are generated by the device in reference to a synchronization timing detected by the device in response to detecting the Y and X coordinate detection signals and the synchronization signals;

The plurality of synchronization signals may include at least three consecutively applied signals.

The Y coordinate detection signal may be applied prior to the synchronization signals, and the synchronization signals may be applied prior to the X coordinate detection signal.

The X coordinate detection signal may be applied prior to the synchronization signals, and the synchronization signals may be applied prior to the Y coordinate detection signal.

The X and Y coordinate detection signals may be applied prior to the synchronization signals.

The synchronization signals may be applied prior to the X and Y coordinate detection signals.

According to an embodiment of the present invention, a method of operating a detection device to detect a location of the detection device is provided. The method includes generating a plurality of sensing signals in response to a plurality of infrared emissions from an infrared emission source, measuring timings of the plurality of sensing signals, determining a synchronization timing by comparing the timings of the plurality of sensing signals with a synchronization condition, determining the location of the detection device in accordance with the synchronization timing and the timings of the plurality of sensing signals, and outputting coordinates of the location of the detection device when the timings of the plurality of sensing signals satisfy the synchronization condition.

Determining a synchronization timing may include comparing timings of at least three consecutive signals of the sensing signals to the synchronization condition.

Determining a synchronization timing may further include comparing a time period between a first one and a second one of the at least three consecutive signals to the synchronization condition, and comparing a time period between the second one and a third one of the at least three consecutive signals to the synchronization condition.

Determining the infrared emission location may include generating a vertical coordinate in accordance with a time period between the synchronization timing and a vertical coordinate detection signal of the sensing signals, and generating a horizontal coordinate in accordance with a time period between the synchronization timing and a horizontal coordinate detection signal of the sensing signals.

### BRIEF DESCRIPTION OF THE DRAWINGS

FIG. 1 is a block diagram of an electronic pen for detecting a touch location, according to an embodiment of the present invention.

FIG. 2 is a block diagram of a plasma display apparatus, according to an embodiment of the present invention.

FIG. 3 is a flowchart illustrating methods of synchronization and detecting a touch location by the electronic pen illustrated in FIG. 1, according to an embodiment of the present invention.

FIG. 4 is a diagram illustrating a driving method of the plasma display apparatus illustrated in FIG. 2, according to an embodiment of the present invention.

FIG. 5 is a diagram illustrating a driving method of a plasma display apparatus, according to another embodiment of the present invention.

FIG. 6 is a diagram illustrating a driving method of a plasma display apparatus, according to another embodiment of the present invention.

FIG. 7 is a diagram illustrating a driving method of a plasma display apparatus, according to another embodiment of the present invention.

### DETAILED DESCRIPTION

Example embodiments of the present invention will now be described more fully hereinafter with reference to the accompanying drawings. As those skilled in the art would realize, the described embodiments may be modified in various different ways, all without departing from the spirit or scope of the present invention.

### Configuration of Electronic Pen

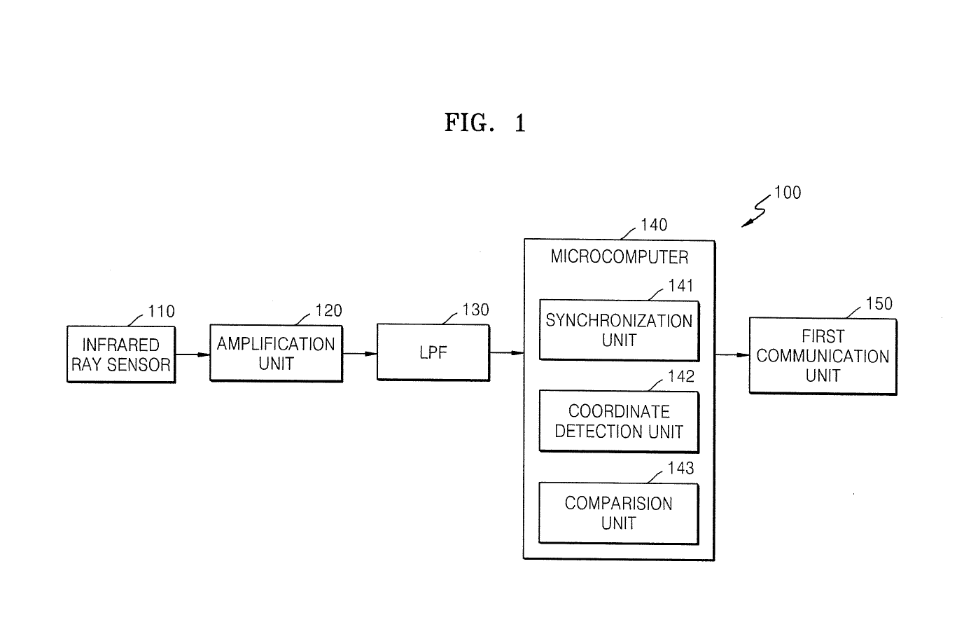

FIG. 1 is a block diagram of an electronic pen 100 for detecting a touch location, according to an embodiment of the present invention.

Referring to FIG. 1, the electronic pen 100 includes an infrared ray sensor 110, an amplification unit 120, a low pass filter (LPF) 130, a microcomputer 140 and a first communication unit 150.

The infrared ray sensor 110 senses an infrared ray generated by a display panel and generates a sensing signal. Since an infrared ray generated by an external device (e.g., a plasma display panel) is sensed, the infrared ray sensor 110 is a passive sensor. The sensing signal may be a current generated by the infrared ray sensor 110 according to the intensity of the infrared ray, or a voltage induced by the current.

For example, in a plasma display apparatus, if a coordinate detection signal for detecting a coordinate is sequentially applied to scan electrodes of a plasma display panel (PDP), an infrared ray is generated along the scan electrodes to which the coordinate detection signal is applied, and the infrared ray sensor 110 senses the generated infrared ray. Here, the coordinate detection signal may be applied to the electrodes during a coordinate detection period that is different from a plurality of subfield periods for displaying an image according to image data. Hereinafter, it is assumed that the display panel is a PDP as an example.

The amplification unit 120 amplifies the sensing signal generated by the infrared ray sensor 110 to an appropriate amplitude. The sensing signal generated by the infrared ray sensor 110 may have a very small amplitude and thus may be vulnerable to noise. Accordingly, the sensing signal is amplified such that the microcomputer 140 may easily perform coordinate detection. The amplification unit 120 may be an operational amplifier (OP Amp).

The LPF 130 removes high-frequency components from the sensing signal amplified by the amplification unit 120. That is, the high-frequency components of the sensing signal are filtered, while the low-frequency components are passed. The touch location detected by the electronic pen 100 does not always correspond to a location where the infrared ray is generated. That is, if the electronic pen 100 touches the PDP in a region where barrier ribs are formed, instead of a region where discharge cells are formed, the electronic pen 100 senses infrared rays generated from two discharge cells adjacent to the electronic pen 100. In this case, the infrared ray sensor 110 generates two sensing signals having the same intensity, therefore, coordinate detection may not be performed based on the sensing signals. However, if the generated sensing signals are passed through the LPF 130, all of the sensing signals have one peak value. Also, the location of the peak value corresponds to the touch location detected by the electronic pen 100. Accordingly, the touch location may be accurately detected by passing the sensing signals through the LPF 130.

The microcomputer 140 synchronizes the electronic pen 100 with a display apparatus for generating infrared rays, and determines the touch location detected by the electronic pen 100 on the display apparatus. The microcomputer 140 may include a synchronization unit 141 and a coordinate detection unit 142. In some embodiments, the microcomputer 140 further includes a comparison unit 143.

The synchronization unit 141 sets or determines a synchronization timing by using the sensing signals generated by the infrared ray sensor 110. The electronic pen 100 and the display apparatus are separate devices and operate according to different system clocks. In an algorithm for detecting the touch location touched by the electronic pen 100, time differences among a time when an infrared ray for detecting an x coordinate is sensed, a time when an infrared ray for detecting a y coordinate is sensed, and a reference time are calculated. If the two devices do not have the same reference time, the time differences may not be calculated. Accordingly, the synchronization unit 141 synchronizes the electronic pen 100 with the display apparatus such that the two devices operate with the same reference time.

The synchronization unit 141 identifies sensing signals generated due to synchronization signals from among sensing signals generated by a plurality of sensed infrared rays. In one embodiment, the display apparatus generates and applies at least three synchronization signals to its electrodes. As such, at least three infrared rays are generated due to the synchronization signals, and thus the electronic pen 100 generates at least three sensing signals as the synchronization signals. If the infrared ray sensor 110 senses a plurality of sequentially generated infrared rays and generates a plurality of sensing signals corresponding to the sensed infrared rays, the synchronization unit 141 detects time periods among timings when the sensing signals are generated. For example, if first through third sensing signals are sequentially generated, the synchronization unit 141 detects a time period between a timing when the first sensing signal is generated and a timing when the second sensing signal is generated, and a time period between the timing when the second sensing signal is generated and a timing when the third sensing signal is generated. If the detected time periods satisfy a preset condition, the synchronization unit 141 recognizes the first through third sensing signals as synchronization signals. Then, the synchronization unit 141 sets a synchronization timing as a timing when one of the first through third sensing signals is generated. Although the above description is exemplarily provided on the assumption that three synchronization signals are applied, the number of synchronization signals is not limited to three, and, in some embodiments, four or more synchronization signals may be used to set the synchronization timing as long as at least three synchronization signals are generated by the PDP. If only two synchronization signals are generated and thus the infrared ray sensor 110 senses infrared rays generated due to the two synchronization signals, one time period is generated by using the two synchronization signals. However, two or more infrared rays may be sensed in a time period other than a synchronization period, but the time period when the infrared rays are sensed may be equal to a time period when two sensing signals are generated due to the two synchronization signals. Thus the electronic pen 100 may be synchronized with the display apparatus in a wrong timing.

As described above, the synchronization unit 141 determines whether timings when a plurality of sensing signals are generated satisfy a synchronization condition. For example, if detected time periods correspond to preset cycles (or preset timings), it may be determined that a condition of detecting the synchronization signals is satisfied. Alternatively, if the detected time periods corresponds to the preset cycles, for example, if a first time period corresponds to a cycle a (e.g., in μs) and a second time period corresponds to a cycle b (e.g., in μs) (a≠b), it may be determined that the condition of detecting the synchronization signals is satisfied.

The coordinate detection unit 142 detects the touch location where the electronic pen 100 touches (or sufficiently close to) the PDP. The touch location may be represented as coordinates. That is, when a bottom left end of the PDP is referred to as an origin of an orthogonal coordinate system and horizontal and vertical directions are respectively represented by x and y axes, the touch location may be represented as coordinates.

The coordinate detection unit 142 detects a time difference between a timing when an infrared ray generated due to an x coordinate detection signal is sensed (hereinafter referred to as “an x coordinate detection signal sensing timing”) and the synchronization timing set by the synchronization unit 141, and also detects a time difference between a timing when an infrared ray generated due to a y coordinate detection signal is sensed (hereinafter referred to as “a y coordinate detection signal sensing timing”) and the synchronization timing. If any one of the x coordinate detection signal sensing timing, the y coordinate detection signal sensing timing and the synchronization timing is not detected, calculation for coordinate detection may not be performed. Accordingly, when detected, the x coordinate detection signal sensing timing, the y coordinate detection signal sensing timing or the synchronization timing may be recorded in a suitable storage and may be read in an operation for coordinate detection. Here, when the time difference is detected, a peak value of a sensing signal filtered by the LPF 130 is shifted in comparison to a sensing signal that is not yet filtered. In this case, a time when the filtered sensing signal has a peak value may be determined as a time when an infrared ray is sensed.

When the time difference for calculating an x coordinate and the time difference for calculating a y coordinate are detected, the coordinate detection unit 142 calculates coordinates of the touch location detected by the electronic pen 100 on the PDP by using the detected time differences. For example, if the PDP sequentially applies a y coordinate detection signal to scan electrodes from a first row to an n-th row (e.g., in a top to bottom direction), a time when an infrared ray is sensed is further delayed as the touch location of the electronic pen 100 is at a lower side (i.e., nearer the bottom side). Accordingly, as a time difference is large, it may be determined that the touch location detected by the electronic pen 100 is at a low side. Likewise, when a horizontal location is detected (e.g., in a left to right direction), as a time difference is large, it may be determined that the touch location detected by the electronic pen 100 is at a right side. However, the above description is exemplarily provided, and the present invention is not limited thereto. In some embodiments, a direction of applying the x coordinate detection signal or the y coordinate detection signal to scan electrodes or address electrodes may be changed, and a coordinate calculation method may be accordingly changed. In a display apparatus such as a plasma display apparatus, a scan driving unit sequentially applies a scan signal to scan electrodes from a first row to an n-th row by using a shift register. Accordingly, coordinate detection may be efficiently performed by using the above-described method.

In some embodiments, the electronic pen 100 may further include the comparison unit 143 for comparing a sensing signal of which high-frequency components are filtered by the LPF 130 to a reference value. The reference value is a threshold value for determining that the electronic pen 100 touches the PDP. The microcomputer 140 determines that the electronic pen 100 touches the PDP only when the comparison unit compares the sensing signal to the reference value and determines that the sensing signal has a value greater than the reference value.

The first communication unit 150 transmits touch location information regarding the touch location detected by the microcomputer 140 to the display apparatus. Due to the transmitted touch location information, the PDP may perform according to a manipulation signal input by the electronic pen 100. For example, a cursor may follow the touch location detected by the electronic pen 100 or a line may be drawn along the touch locations detected by the electronic pen 100. The first communication unit 150 may use wireless communication technology such as radio frequency identification (RFID) technology or BLUETOOTH® technology.

### Configuration of Plasma Display Apparatus

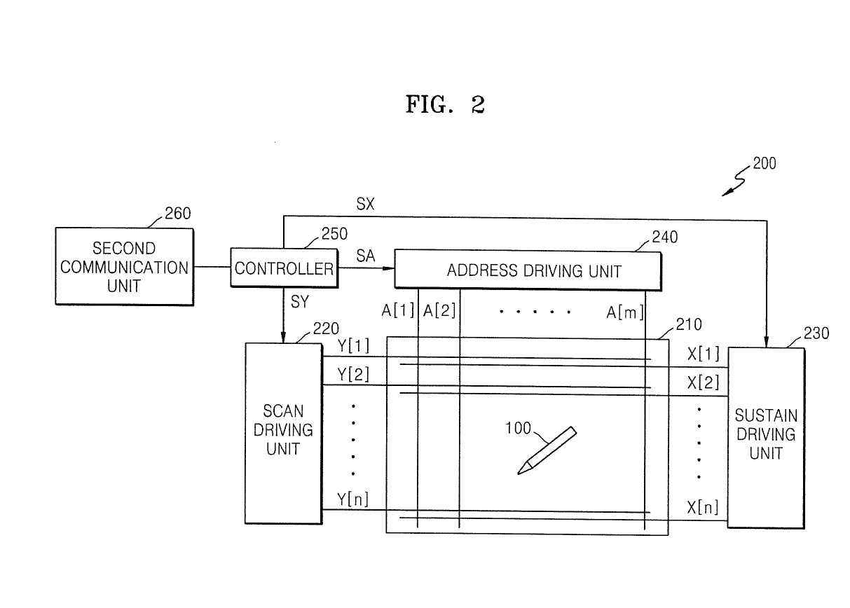

FIG. 2 is a block diagram of a plasma display apparatus 200, according to an embodiment of the present invention.

Referring to FIG. 2, the plasma display apparatus 200 includes a PDP 210, a scan driving unit 220, a sustain driving unit 230, an address driving unit 240, a controller 250 and a second communication unit 260.

In the PDP 210, a plurality of scan electrodes Y[1] through Y[n], a plurality of sustain electrodes X[1] through X[n] and a plurality of address electrodes A[1] through A[m] are formed. The scan electrodes Y[1] through Y[n] and the sustain electrodes X[1] through X[n] extend in parallel, and the address electrodes A[1] through A[m] extend to orthogonally cross the scan electrodes Y[1] through Y[n] and the sustain electrodes X[1] through X[n]. Discharge cells may be located in the crossing regions of the electrodes.

The controller 250 receives an image signal such as 8-bit red (R), green (G) and blue (B) image data, a clock signal and vertical and horizontal synchronization signals, and also receives touch location information from the second communication unit 260. The controller 250 generates scan, sustain and address driving control signals SA, SY and SX based on the received image signal and the touch location information.

The scan driving unit 220 receives the scan driving control signal SY from the controller 250 and generates a scan signal. The scan driving unit 220 applies the generated scan signal to the scan electrodes Y[1] through Y[n].

The sustain driving unit 230 receives the sustain driving control signal SX from the controller 250 and generates a sustain signal. The sustain driving unit 230 applies the generated sustain signal to the sustain electrodes X[1] through X[n].

The address driving unit 240 receives the address driving control signal SA from the controller 250 and generates a display data signal. The address driving unit 240 applies the generated display data signal to the address electrodes A[1] through A[m].

The second communication unit 260 receives the touch location information from the electronic pen 100 illustrated in FIG. 1 and transmits the touch location information to the controller 250.

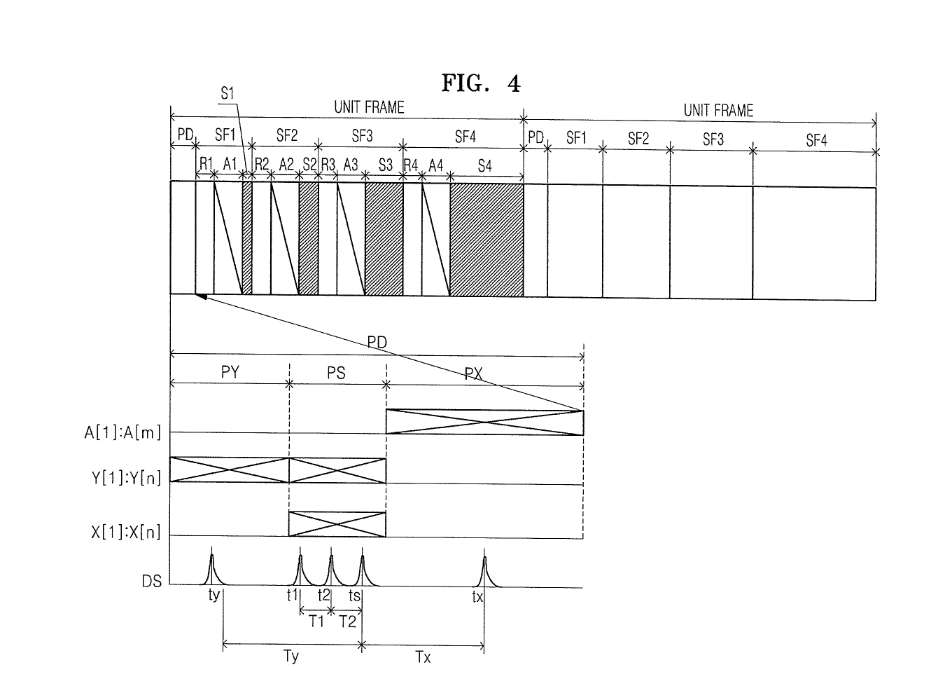

The plasma display apparatus 200 may be driven in a plurality of subfields, e.g., SF1 through SF4, having different weights in one unit frame in order to represent a grayscale with a plurality of gray levels, and may also be driven in a coordinate detection period PD in addition to the subfields SF1 through SF4 in order to detect a touch location by the electronic pen 100 (see FIG. 4). The subfields SF1 through SF4 may respectively include reset periods R1 through R4, address periods A1 through A4 and sustain periods S1 through S4 (see FIG. 4).

Here, during the coordinate detection period PD, the scan driving unit 220 may generate synchronization signals and a y coordinate detection signal for detecting a y coordinate, the address driving unit 240 may generate an x coordinate detection signal for detecting an x coordinate, and the sustain driving unit 230 may generate synchronization signals. In this case, the x coordinate detection signal and the y coordinate detection signal are signals for coordinate detection, and thus are sequentially applied to the scan electrodes Y[1] through Y[n] and the address electrodes A[1] through A[m]. On the other hand, the synchronization signals are signals for performing synchronization with the electronic pen 100, and therefore infrared rays generated due to the synchronization signals have to be sensed regardless where the touch location is detected by the electronic pen 100. Accordingly, the synchronization signals are concurrently (e.g., simultaneously) applied to all of the scan electrodes Y[1] through Y[n] and the sustain electrodes X[1] through X[n].

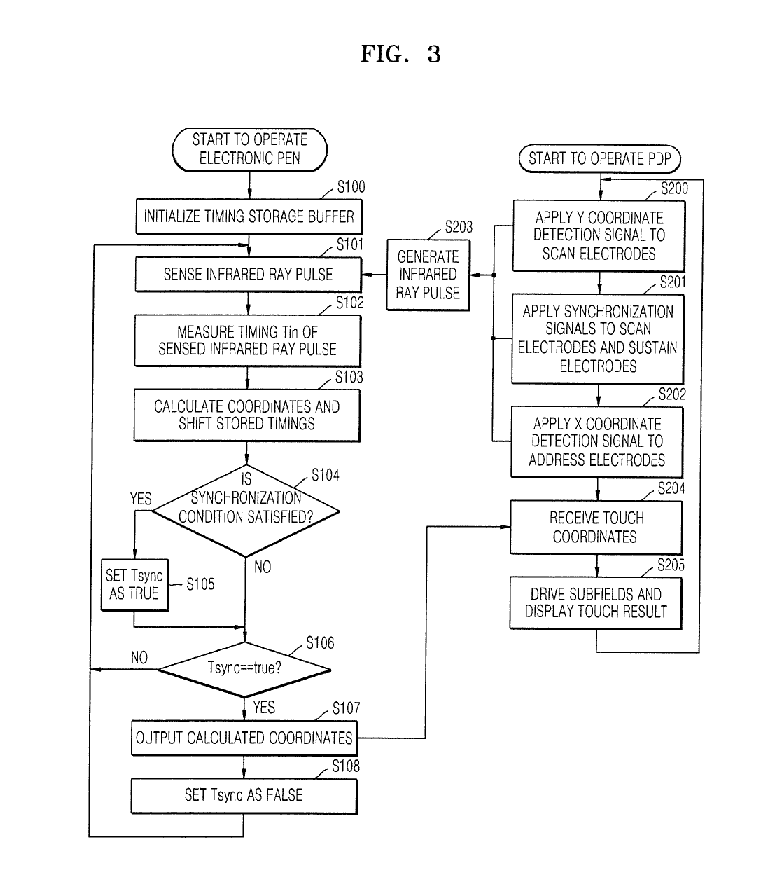

Touch location detection and synchronization operations will now be described in more detail with reference to FIGS. 3 and 4.

FIG. 3 is a flowchart illustrating methods of synchronization and detecting a touch location by the electronic pen 100 illustrated in FIG. 1, according to an embodiment of the present invention, and FIG. 4 is a diagram illustrating a driving method of the plasma display apparatus 200 illustrated in FIG. 2, according to an embodiment of the present invention.

### Operation of Plasma Display Apparatus

For the convenience of explanation, operation of the plasma display apparatus 200 will be described first.

If the plasma display apparatus 200 starts to operate, for example, if the plasma display apparatus 200 is turned on, the plasma display apparatus 200 is repeatedly driven in a unit frame formed of a coordinate detection period PD and a plurality of subfields SF1 through SF4 in order to obtain touch location information from the electronic pen 100 and to display an image in a plurality of gray levels.

In FIG. 3, the plasma display apparatus 200 is driven in the coordinate detection period PD first. In more detail, initially, in a y coordinate detection period PY, a y coordinate detection signal is applied to scan electrodes Y[1] through Y[n] (S200).

Then, in a synchronization period PS, synchronization signals are applied to the scan electrodes Y[1] through Y[n] and sustain electrodes X[1] through X[n] (operation S201). In one embodiment, three or more synchronization signals are applied for performing accurate synchronization with the electronic pen 100. In other words, three or more infrared rays have to be generated from discharge cells.

In addition, in an x coordinate detection period PX, an x coordinate detection signal is applied to address electrodes A[1] through A[m] (operation S202).

Each of the signals applied to the electrodes in operations S200 through S202 generates an infrared ray pulse (operation S203). In this case, as illustrated in FIG. 4, the electronic pen 100 generates a sensing signal DS in each of the x coordinate detection period PX and the y coordinate detection period PY. Also, the electronic pen 100 generates a number of sensing signals DS corresponding to the number of synchronization signals applied in the synchronization period PS.

The touch location information, i.e., information regarding x and y coordinates, is received from the electronic pen 100 (operation S204), and a touch result is displayed on the PDP 210 according to the received touch location information (operation S205). In this case, the subfields SF1 through SF4 are performed together based on an image signal and an image is displayed (operation S200). That is, the image and the touch result may be concurrently (e.g., simultaneously) displayed on the PDP 210.

One unit frame is completely driven by performing operations S200 through S205, and the operation of the plasma display apparatus 200 returns to operation S200 so as to drive a new unit frame.

As such, the touch location detection and synchronization operations in the plasma display apparatus 200 are completed.

### Operation of Electronic Pen

Operation of the electronic pen 100 will now be described in more detail.

If the electronic pen 100 starts to operate, for example, if the electronic pen 100 is turned on, a timing storage buffer of the electronic pen 100 is initialized (operation S100). The timing storage buffer temporarily stores timings when infrared ray pulses are sensed. The timing storage buffer may store values of Ty, Tx, T1, T2, ty, t1, t2, ts, tx and Tsync. Ty and Tx are values representing coordinates detected by the electronic pen 100, and T1 and T2 are values related to synchronization of the electronic pen 100. Also, ty, t1, t2, ts and tx are values representing timings when infrared ray pulses are sensed, and Tsync is a value representing whether the electronic pen 100 is synchronized with a display apparatus (e.g., the plasma display apparatus 200 in FIG. 2). As the timing storage buffer is initialized, the values are set as ty=t1−t2=ts=tx=0, T1=T2=0, Tx=Ty=0, and Tsync=false.

After the timing storage buffer is initialized, the infrared ray sensor 110 continuously senses the infrared ray pulses generated by the PDP 210 (operation S101), and then measures a timing Tin of each of the sensed infrared ray pulses (operation S102).

The measured timing Tin is applied to the timing storage buffer, and the timing storage buffer shifts its data. The shifted data is used to calculate coordinates. In one embodiment, Ty, Tx, T1 and T2 are respectively calculated as Ty=ts−ty, Tx=tx−ts, T1=t2−t1, and T2=ts−t2. The values of ty, t1, t2, ts and tx are respectively shifted as ty=t1; t1=t2; t2=ts; ts=tx; tx=Tin (operation S103).

Then, it is determined whether the T1 and T2 calculated using shifted values satisfy a synchronization condition (operation S104). If both of T1 and T2 satisfy the synchronization condition, Tsync is set as true (operation S105).

The value of Tsync is either true or false (operation S106). If Tsync is not true, synchronization is not performed, and thus the operation of the electronic pen 100 returns to operation S101. On the other hand, if Tsync is true, synchronization is performed, and thus the calculated coordinates are output to the PDP 210 via the first communication unit 150 (operation S107). Then, in order to perform synchronization with respect to a new unit frame, Tsync is set as false, and the operation of the electronic pen 100 returns to operation S101.

As such, the touch location detection and synchronization operations in the electronic pen 100 are completed.

As described above, as the plasma display apparatus 200 is additionally driven in the synchronization period PS to synchronize the electronic pen 100 with the plasma display apparatus 200, the touch location may be accurately detected by the electronic pen 100.

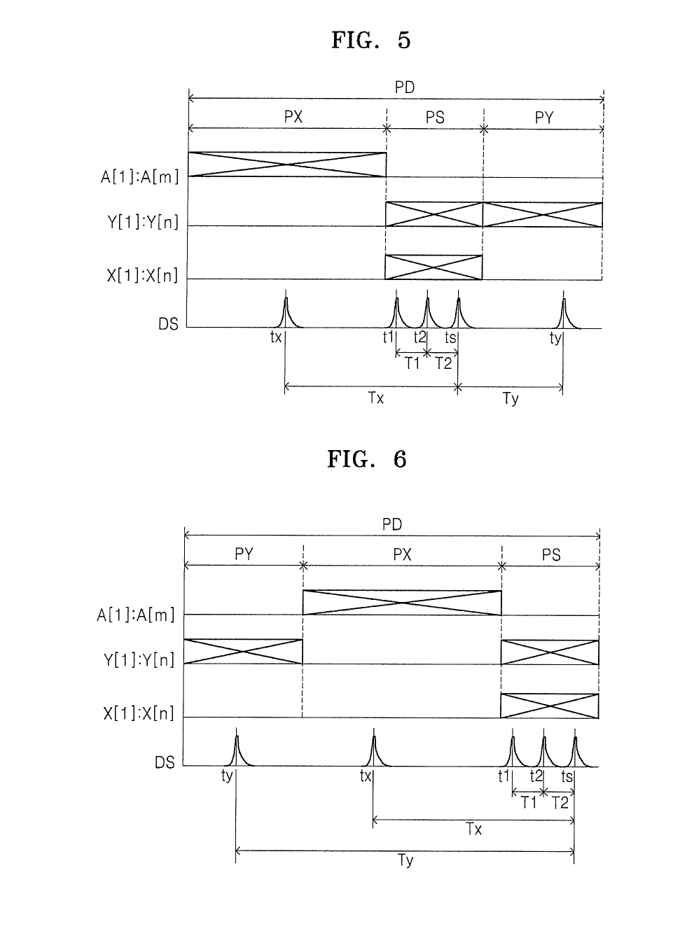

FIG. 5 is a diagram illustrating a driving method of a plasma display apparatus, according to another embodiment of the present invention.

In FIG. 5, the plasma display apparatus is driven in a coordinate detection period PD in the order of an x coordinate detection period PX, a synchronization period PS and a y coordinate detection period PY. Accordingly, the electronic pen 100 illustrated in FIG. 1 initially senses an infrared ray generated due to an x coordinate detection signal in a timing tx, and then senses infrared rays generated due to synchronization signals in timings t1, t2 and ts and sets ts as a synchronization timing. Lastly, the electronic pen 100 senses infrared rays generated due to a y coordinate detection signal in a timing ty.

Except for the driving order in the coordinate detection period PD, operations in FIG. 5 are the same as the operations in FIG. 4. In FIG. 5, a data order of a timing storing buffer is tx=t1; t1=t2; t2=ts; ts=ty; ty=Tin, and Tx=ts−tx and Ty=ty−ts.

FIG. 6 is a diagram of a driving method of a plasma display apparatus, according to another embodiment of the present invention.

In FIG. 6, the plasma display apparatus is driven in a coordinate detection period PD in the order of a y coordinate detection period PY, an x coordinate detection period PX and a synchronization period PS. Accordingly, the electronic pen 100 illustrated in FIG. 1 initially senses an infrared ray generated due to a y coordinate detection signal in a timing ty, and then senses an infrared ray generated due to a x coordinate detection signal in a timing tx. Lastly, the electronic pen 100 senses infrared rays generated due to synchronization signals in timings t1, t2 and ts. In this case, ts is set as a synchronization timing.

Except for the driving order in the coordinate detection period PD, operations in FIG. 6 are the same as the operations in FIG. 4. In FIG. 6, a data order of a timing storing buffer is ty=tx; tx=t1; t1=t2; t2=ts; ts=Tin, and Tx=ts−tx and Ty=ts−ty.

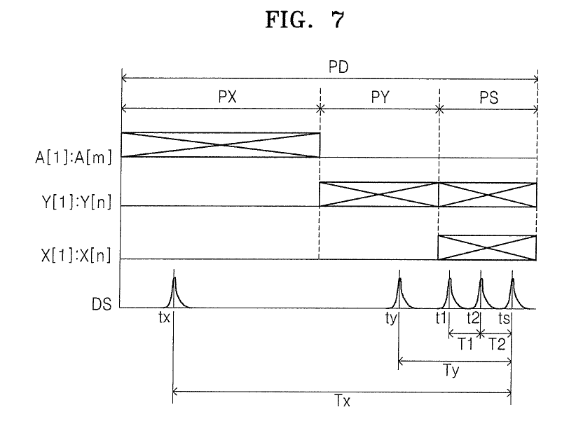

FIG. 7 is a diagram of a driving method of a plasma display apparatus, according to another embodiment of the present invention.

In FIG. 7, the plasma display apparatus drives a coordinate detection period PD in the order of an x coordinate detection period PX, a y coordinate detection period PY and a synchronization period PS.

Except for the driving order in the coordinate detection period PD, operations in FIG. 7 are the same as the operations in FIG. 4. In FIG. 7, a data order of a timing storing buffer is tx=ty; ty=t1; t1=t2; t2=ts; ts=Tin, and Tx=ts−tx and Ty=ts−ty.

The driving order of the x coordinate detection period PX, the y coordinate detection period PY and the synchronization period PS in the coordinate detection period PD is not limited to the above-mentioned driving orders and may be variously changed. For example, in the coordinate detection period PD, the synchronization period PS may be performed first, and then the x coordinate detection period PX or the y coordinate detection period PY may be performed.

Also, although the above descriptions are provided on the assumption that the coordinate detection period PD is performed after a plurality of subfields SF1 through SF4, the driving order is not limited thereto. That is, the coordinate detection period PD may be located between the subfields SF1 through SF4.

The exemplary embodiments described herein should be considered in a descriptive sense only and not for purposes of limitation. Accordingly, it will be understood by those of ordinary skill in the art that various changes in form and details may be made without departing from the spirit and scope of the present invention as set forth in the following claims and their equivalents.

What is claimed is:

1. A detection device comprising:
a sensor for receiving infrared emissions and for generating a plurality of sensing signals in response to the infrared emissions;
a synchronization unit for determining a synchronization timing in accordance with timings of the plurality of sensing signals; and
a coordinate detection unit for detecting a location of the detection device in accordance with time differences between the synchronization timing and the timings of the plurality of sensing signals.

2. The detection device of claim 1, wherein the synchronization unit is adapted to generate the synchronization timing by comparing the timings of at least three consecutive sensing signals among the sensing signals with a synchronization condition.

3. The detection device of claim 2, wherein the detection device is configured to compare a first value with a time period between a first one and a second one of the at least three consecutive sensing signals, and to compare a second value with a time period between the second one and a third one of the at least three consecutive sensing signals, to determine the synchronization condition.

4. The detection device of claim 1,
wherein the coordinate detection unit is adapted to generate a vertical coordinate in accordance with a time period between the synchronization timing and a vertical coordinate detection signal of the sensing signals, and
wherein the coordinate detection unit is adapted to generate a horizontal coordinate in accordance with a time period between the synchronization timing and a horizontal coordinate detection signal of the sensing signals.

5. The detection device of claim 1, wherein the sensor comprises:
an infrared sensor for generating the plurality of sensing signals; and
an amplifier coupled to the infrared sensor and configured for amplifying the plurality of sensing signals.

6. The detection device of claim 5, further comprising a low pass filter for removing high frequency components of the sensing signals, the high frequency components corresponding to a time period between two of the infrared emissions from two adjacent pixels, respectively, of a display apparatus.

7. The detection device of claim 1, further comprising a comparison unit for comparing a value of one of the sensing signals with a reference value such that the value of one of the sensing signals is greater than the reference value when the detection device is sufficiently close to the infrared emissions.

8. The detection device of claim 1, further comprising a communication unit for transmitting coordinates of the detection device as an output.

9. A method of driving a plasma display panel of a display apparatus to detect a touch location of a device on the plasma display panel, the plasma display panel comprising a plurality of first electrodes and a plurality of third electrodes extending in a first direction and a plurality of second electrodes extending in a second direction crossing the first direction, the plasma display panel driven in a frame comprising a plurality of subfields and a coordinate detection period, the method comprising:
applying a Y coordinate detection signal to the first electrodes during a Y coordinate detection period of the coordinate detection period;
applying an X coordinate detection signal to the second electrodes during an X coordinate detection period of the coordinate detection period;
applying a plurality of synchronization signals concurrently to the first electrodes and the third electrodes during a synchronization period of the coordinate detection period;
receiving coordinates of the touch location from the device in data communication with the display apparatus, the coordinates being generated by the device in reference to a synchronization timing detected by the device in response to detecting the Y and X coordinate detection signals and the synchronization signals; and
driving the plasma display panel during the plurality of subfields to display the touch location.

10. The method of claim 9, wherein the plurality of synchronization signals comprises at least three consecutively applied signals.

11. The method of claim 9, wherein the Y coordinate detection signal is applied prior to the synchronization signals, and the synchronization signals are applied prior to the X coordinate detection signal.

12. The method of claim 9, wherein the X coordinate detection signal is applied prior to the synchronization signals, and the synchronization signals are applied prior to the Y coordinate detection signal.

13. The method of claim 9, wherein the X and Y coordinate detection signals are applied prior to the synchronization signals.

14. The method of claim 9, wherein the synchronization signals are applied prior to the X and Y coordinate detection signals.

15. A method of operating a detection device to detect a location of the detection device, the method comprising:
generating a plurality of sensing signals in response to a plurality of infrared emissions from an infrared emission source;
measuring timings of the plurality of sensing signals;
determining a synchronization timing by comparing the timings of the plurality of sensing signals with a synchronization condition;
determining the location of the detection device in accordance with the synchronization timing and the timings of the plurality of sensing signals; and
outputting coordinates of the location of the detection device when the timings of the plurality of sensing signals satisfy the synchronization condition.

16. The method of claim 15, wherein said determining a synchronization timing comprises comparing timings of at least three consecutive signals of the sensing signals to the synchronization condition.

17. The method of claim 16, wherein said determining a synchronization timing further comprises:
comparing a time period between a first one and a second one of the at least three consecutive signals to the synchronization condition, and
comparing a time period between the second one and a third one of the at least three consecutive signals to the synchronization condition.

18. The method of claim 15, wherein said determining the location of the detection device comprises:
generating a vertical coordinate in accordance with a time period between the synchronization timing and a vertical coordinate detection signal of the sensing signals, and
generating a horizontal coordinate in accordance with a time period between the synchronization timing and a horizontal coordinate detection signal of the sensing signals.
